(19) United States
(12) Patent Application Publication
(10) Pub. No.: US 2005/0022847 A1
(43) Pub. Date: Feb. 3, 2005

(54) Dish washing machine

(76) Inventors: Hideyuki Nito, Osaka (JP); Kiyoyuki Suo, Osaka (JP); Hajime Suzuki, Osaka (JP)

Correspondence Address: RABIN & Berdo, PC, 1101 14TH STREET, NW, SUITE 500, WASHINGTON, DC, 20005, US

(21) Appl. No.: 10/902,526

(22) Filed: Jul. 30, 2004

(30) Foreign Application Priority Data
Jul. 31, 2003 (JP) 2003-204964

(51) Int. Cl. B08B 3/02

(52) U.S. Cl. 134/57 D; 134/58 D; 134/113; 134/94.1; 134/200

(57) ABSTRACT

A dish washing machine according to the present invention carries out, in a kitchen detergent course, a soaking step for spraying a wash water stored in a containing tank toward dishes and leaving the dishes for a predetermined time precedent to a washing step. In the soaking step, a low temperature soaking is carried out in which the wash water in a washing tank is kept at about 30° C. (temperature appropriate for removing soils containing protein ingredients with a kitchen detergent, especially a neutral detergent), and thereafter a high temperature soaking is carried out in which the wash water in the washing tank is kept at about 50° C. Thereby, the soils containing protein ingredients attached to the dishes can be well removed away with the kitchen detergent.

### BACKGROUND OF THE INVENTION

1. Field of the Invention

The present invention relates to a dish washing machine capable of washing dishes by spraying a wash water toward dishes contained in a washing tank.

2. Description of Related Art

Usually, in a dish washing machine, a special detergent (mostly a powder detergent) is mixed with water stored in a washing tank to make a wash water, and by spraying the wash water toward dishes, the dishes can be washed (see, for example, Japanese Unexamined Patent Publication No. 8-140919(1996)). Plural nozzles are provided in the washing tank, and the wash water stored in the washing tank is sucked by a washing pump and sprayed through the plural nozzles toward the dishes. And the sprayed wash water is stored in the washing tank and sprayed through the plural nozzles toward the dishes again.

In the dish washing machine, the wash water is forcibly sprayed through the plural nozzles and at the same time the wash water in the washing tank is circulated for use. Accordingly, the detergent is apt to foam more in comparison with the case of washing the dishes by hands. Especially when few soils are attached to the dishes like the case in which the dishes once washed by hands are washed by the dish washing machine, the detergent is apt to foam more to form a large amount of foam in the washing tank. If a large amount of foam is formed in the washing tank, there occur such troubles as lowering of the washing ability and leaking of foam to the outside of the machine. Consequently, the special detergent for use in the dish washing machines is hard to foam in comparison with an ordinary kitchen detergent used for washing the dishes by hands.

It is convenient that the dishes can be washed with the kitchen detergent in the dish washing machine, for example, when a user has forgotten to buy the special detergent. However, the kitchen detergent has different properties from those of the special detergent (for example, washing ability of the kitchen detergent changes depending on temperature) Therefore, when washing the dishes with the kitchen detergent in the dish washing machine, sometimes the dishes cannot be well washed if a user does not wash the dishes in such a manner as suitable for the kitchen detergent.

Further, some users want to use the dish washing machine only for rinsing the dishes after washing the same with the kitchen detergent by hands. However, if detergent ingredients are left on the dishes washed with the kitchen detergent by hands, a large amount of foam is apt to be formed in the washing tank during rinsing.

### SUMMARY OF THE INVENTION

The present invention has been made in such backgrounds, and a main object of the present invention is to provide a dish washing machine capable of washing dishes well even with kitchen detergent.

Another object of the present invention is to provide a dish washing machine capable of preventing a large amount of foam from being formed in a containing tank (a washing tank).

In the dish washing machine according to the present invention, the dishes can be suitably washed with the kitchen detergent (especially neutral detergent) used for washing the dishes by hands. For this purpose, the dish washing machine according to the present invention is provided with a means for carrying out a soaking step. Since the soaking step can be carried out by that means, soils attached to the dishes can be well removed away. Therefore, even in the case of washing the dishes with the kitchen detergent, the dishes can be well washed.

### BRIEF DESCRIPTION OF THE DRAWINGS

FIG. 1 is a perspective view of a dish washing machine according to one embodiment of the present invention seen obliquely from its front side.

FIG. 2 is a sectional view of the dish washing machine sectioned along a vertical plane in a direction of the depth of the dish washing machine and seen from the right side.

FIG. 3 is a front view, seen from the front side, of the dish washing machine with an upper door and a lower door being removed.

FIG. 4 is a sectional view of the dish washing machine sectioned along a horizontal plane in a direction of the depth of the machine and seen from above.

FIG. 5 is a side view of a washing tank seen from the right side.

FIG. 6 is a block diagram showing an electric arrangement of the dish washing machine.

FIG. 7 is a flow chart showing a flow of control by a control section in a special detergent course.

FIG. 8 is a time chart showing operational states of a water inlet valve and a washing and draining pump in a provisional step.

FIG. 9 is a flow chart showing a flow of control by the control section in a kitchen detergent course.

FIG. 10 is a time chart showing an example of temperature change of wash water (or tap water) in the washing tank in a case of carrying out a high temperature washing in the kitchen detergent course.

FIGS. 11(a) and (b) are flowcharts showing driving states of a pump motor in the soaking step in the case of carrying out the high temperature washing in the kitchen detergent course.

FIG. 12 is a flow chart showing a flow of control by the control section in a rinsing and drying course.

FIG. 13 is a time chart showing an example of temperature change of the tap water in the washing tank in the rinsing and drying course.

FIG. 14 is a flow chart showing driving state of the pump motor during a poring step in the rinsing and drying course.

### DESCRIPTION OF THE PREFERRED EMBODIMENTS

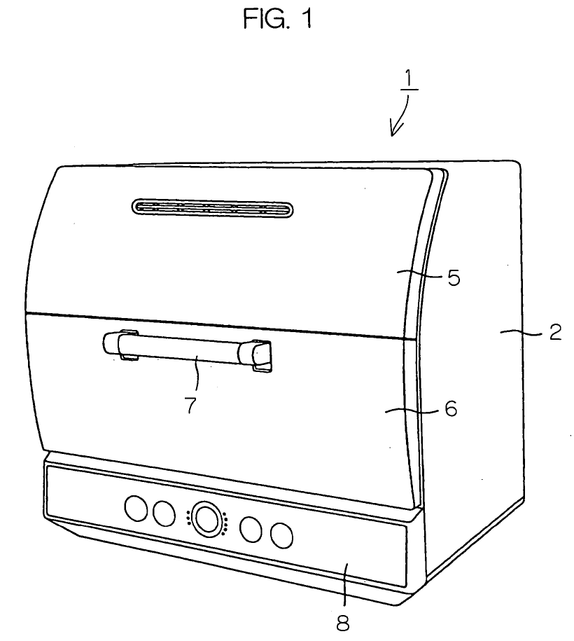

FIG. 1 is a perspective view of a dish washing machine 1 according to one embodiment of the present invention seen obliquely from its front side.

Referring to FIG. 1, the dish washing machine 1 has an outer shape of a substantially rectangular parallelepiped box-shaped body 2. The box-shaped body 2 is so formed that its length from the front end to the rear end (depth) is shorter than its length from the right end to the left end (width).

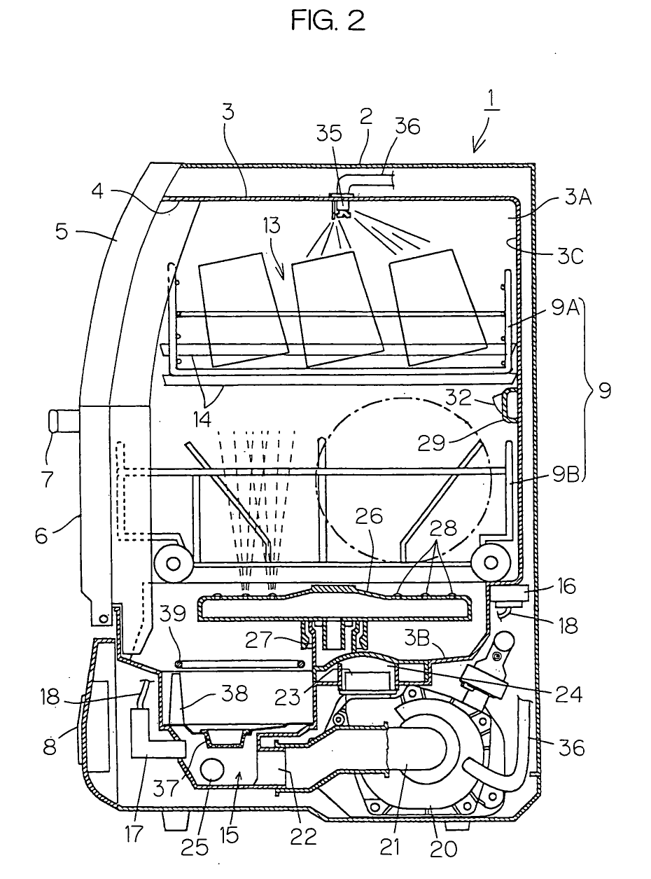

Disposed within the box-shaped body 2 is a washing tank 3 for containing dishes, and an opening 4 is provided in front of the washing tank 3 (see FIG. 2). The opening 4 can be covered with two doors (an upper door 5 and a lower door 6) pivotally attached to the box-shaped body 2. The upper door 5 can cover substantially the upper half of the opening 4 and the lower door 6 can cover substantially the lower half of the opening 4. The upper door 5 is pivotally movable in a forward and upward direction, while the lower door 6 is pivotally movable in a forward and downward direction. When the upper door 5 and the lower door 6 are closed, the opening 4 is covered so that the washing tank 3 is water-tightly sealed.

Provided in a middle portion along the width of the lower door 6 of an upper end portion thereof is a handle 7, which a user holds at the time of opening the lower door 6. When the user holds the handle 7 and pulls the same forward, the lower door 6 is pivotally moved in the forward and downward direction. The upper door 5 is movable in an interlocking manner with the lower door 6. When the lower door 6 is pivotally moved in the forward and downward direction, the upper door 5 is pivotally moved in the forward and upward direction in the interlocking manner with the lower door 6, and the opening 4 is widely opened.

In a lower portion of the front surface of the box-shaped body 2, an operation display panel 8 is provided for setting operations of the dish washing machine 1 (operation course and the like) and displaying operation states and the like.

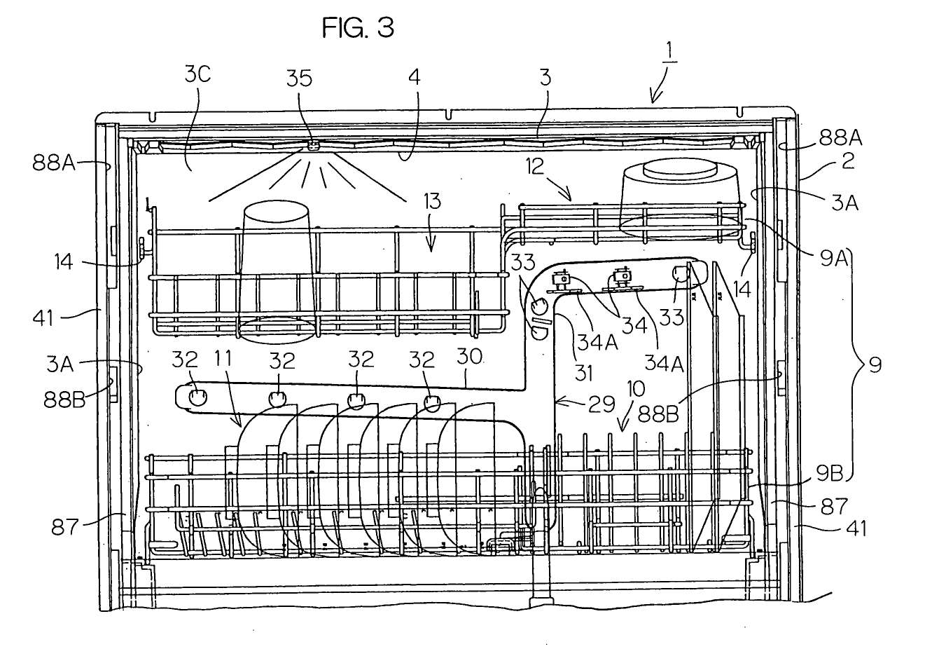

FIG. 2 is a sectional view of the dish washing machine 1 sectioned along a vertical plane in a direction of the depth of the machine 1 and seen from the right side. FIG. 3 is a front view, seen from the front side, of the dish washing machine 1 with the upper door 5 and the lower door 6 being removed. In FIG. 3, the lower part of the dish washing machine 1 is omitted.

Referring to FIGS. 2 and 3, in the washing tank 3, two dish baskets 9 (an upper basket 9A and a lower basket 9B) for supporting dishes to be washed are disposed with a predetermined space therebetween in a vertical direction. Each of the upper basket 9A and the lower basket 9B is slidable in a direction of the depth. With the upper door 5 and the lower door 6 being opened, each of the baskets 9A and 9B can be forwardly pulled out through the opening 4, so that the dishes can be easily put into and out of the dish washing machine 1.

A right side part (in a range of about a third from the right end) of the lower basket 9B is a large plate containing section 10 in which relatively large plates or platters such as dinner plates or salad plates can be contained in an upright state. Further, a part from the central portion to the left side of the lower basket 9B (in a range of about two thirds from the left end) is a bowl containing section 11 in which bowls such as soup bowls or salad dishes can be contained in the laterally upright state.

A right side part (in a range of about a third from the right end) of the upper basket 9A is a small bowl containing section 12 for containing small bowls. Further, a part from the central portion to the left side of the upper basket 9A (in a range of about two thirds from the left end) is a glass containing section 13 for containing glasses, teacups, or the like. In the small bowl containing section 12, four bowls in total can be contained in such a manner that two bowls are arranged right and left in each of two (the front and rear) rows. In the glass containing section 13, twelve glasses in total can be contained in such a manner that four glasses are arranged from right to left in each of three (the front, middle and rear) rows. The bowls to be contained in the small bowl containing section 12 and the glasses or teacups to be contained in the glass containing section 13 are set with their bottoms up.

The large plates or the like to be contained in the large plate containing section 10 require larger vertical spaces than the soup bowls or the like to be contained in the bowl containing section 11 require. On the other hand, the small bowls to be contained in the small bowl containing section 12 require smaller vertical spaces than the glasses or the like to be contained in the glass containing section 13 require. Therefore, in this embodiment, the small bowl containing section 12 is disposed above the large plate containing section 10, the glass containing section 13 is disposed above the bowl containing section 11, and the glass containing section 13 is disposed lower by a degree than the small bowl containing section 12. As a result, the dishes can be efficiently contained in the upper basket 9A and the lower basket 9B. Further, in vacant spaces in peripheral portions or the like of the upper basket 9A and the lower basket 9B, small dishes can be contained in the upright state.

In an upper portions of right and left inner side surfaces 3A, 3B of the washing tank 3, vertically spaced two pairs of rails 14 are provided in parallel with a predetermined spaces therebetween (in FIG. 2, only left side rails 14 are shown) Each pair of rails 14 engages with right and left side edge portions of the upper basket 9A and thereby supports the upper basket 9A so as to be slidable in forward and rearward directions. With this structure, a height of the upper basket 9A can be doubly changed over, depending upon which one of the vertically provided two pairs of rails 14 the right and left side edge portions of the upper basket 9A engage with. When the right and left side edge portions of the upper basket 9A engage with the upper pair of rails 14 and the upper basket 9A is held at a higher position, a rather large space can be defined above the large plate containing section 10, so that even especial large plates can be well contained in the large plate containing section 10.

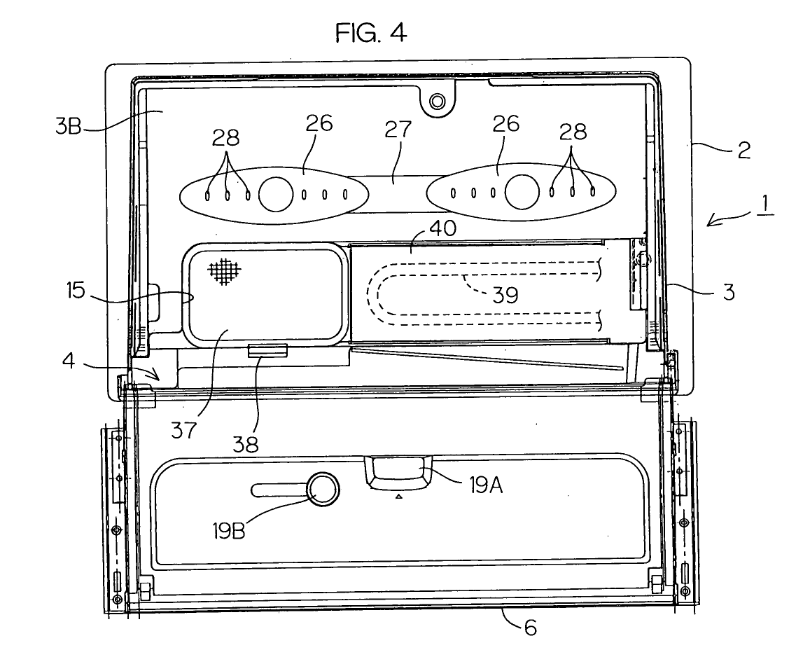

FIG. 4 is a sectional view of the dish washing machine 1 sectioned along a horizontal plane in a direction of the depth of the machine 1 and seen from above, in which the lower door 6 is opened.

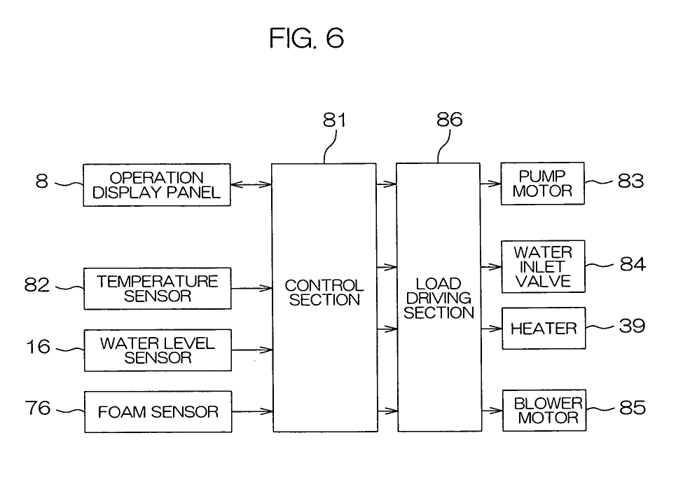

Referring to FIGS. 2 to 4, a water storing section 15 for storing a wash water is provided at front and left portion, lower by a degree, of a bottom 3B of the washing tank 3. A tap water can be supplied into the washing tank 3, for example, from a water supply installation or a hot water supply installation from outside of the dish washing machine 1. The tap water supplied into the washing tank 3 is stored in the lower portion of the washing tank 3 including the water storing section 15. The tap water from the water supply installation and the tap water (hot water) from the hot water supply installation is supplied into the washing tank 3 by opening or closing a water inlet valve 84 (see FIG. 6) In a case of supplying the hot water from the hot water supply installation through the water inlet valve 84 into the washing tank 3, such an operation is set by an operation display panel 8, for example. By throwing a detergent into the washing tank 3, the detergent is mixed with the tap water supplied into the washing tank 3 and thereby the wash water used for washing the dishes is obtained.

A water level of the wash water (or the tap water) stored in the washing tank 3 can be detected by a water level sensor (pressure sensor) 16 provided in a lower rear portion of the washing tank 3. An air trap 17 is communicated with the water storing section 15, and the air trap 17 and the water level sensor 16 are connected by an air hose 18. With such a structure, an air pressure in the air trap 17 changes in accordance with the change of the water level in the washing tank 3. Consequently, by detecting the air pressure change in the air trap 17 by the water level sensor 16, the water level of the wash water stored in the washing tank 3 can be detected.

Substantially in the middle portion of the inner surface of the lower door 6 (the surface on the washing tank 3 side when the lower door 6 is closed), a recess for containing a (generally powder-type) special detergent (a special detergent containing section 19A) is formed. On the left side of the special detergent containing section 19A, a recess for containing a (generally liquid-type) kitchen detergent (a kitchen detergent containing section 19B) is formed (see FIG. 4). In this dish washing machine 1, two different operation courses can be carried out. One is a course in which, with the special detergent being contained in the special detergent containing section 19A, the special detergent is mixed with the tap water supplied into the washing tank 3 and the dishes are washed with thus obtained wash water (a special detergent course), and another is a course in which, with the kitchen detergent being contained in the kitchen detergent containing section 19B, the kitchen detergent is mixed with the tap water supplied into the washing tank 3 and the dishes are washed with thus obtained wash water (a kitchen detergent course).

The special detergent containing section 19A and the kitchen detergent containing section 19B respectively have different shapes. That is, the special detergent containing section 19A is substantially rectangular in plan view, while the kitchen detergent containing section 19B is substantially circular in plan view. When the lower door 6 is opened, the openings of the special detergent containing section 19A and the kitchen detergent containing section 19B respectively are upward, and therefore the special detergent and the kitchen detergent can be contained therein. When the lower door 6 is closed after putting the special detergent in the special detergent containing section 19A or the kitchen detergent in the kitchen detergent containing section 19B, the special detergent in the special detergent containing section 19A or the kitchen detergent in the kitchen detergent containing section 19B drops into the washing tank 3 and is mixed with the tap water supplied into the washing tank 3.

In a case of washing the dishes in the kitchen detergent course, the amount of the kitchen detergent to be used is preferably about 5 ml. There are neutral, alkalescent and acidulant kitchen detergent. If the amount of the detergent is about 5 ml, the dishes can be sufficiently washed with any kind of detergent.

Provided below the washing tank 3 (behind the water storing section 15) is a washing and draining pump 20 for circulating the wash water in the washing tank 3 at the time of dish washing, and draining the wash water in the washing tank 3. Though not shown in FIG. 2, the inside of the washing and draining pump 20 is divided into a washing pump chamber and a draining pump chamber, and the washing pump chamber and the draining pump chamber respectively are provided with a washing impeller and a drain impeller each rotatably driven by a pump motor 83 (see FIG. 6).

An inlet opening 21 of the washing pump chamber is connected to a circulation opening 22 formed in a rear wall of the water storing section 15, while an outlet opening 23 of the washing pump chamber is connected to a water channel 24 elongated in a direction of the width below the washing tank 3. The water channel 24 is connected to a rotary nozzle arm and a fixed nozzle arm mentioned below. When the pump motor 83 is normally rotated, a rotation of the washing impeller in the washing pump chamber makes the wash water sucked from the water storing section 15 through the circulation opening 22 into the washing pump chamber. The wash water is then supplied through the outlet opening 23 into the water channel 24. The wash water supplied under pressure thorough the water channel 24 is sprayed, through the rotary nozzle arm and the fixed nozzle arm, toward the dishes in the washing tank 3. The wash water sprayed through the rotary nozzle arm and the fixed nozzle arm is stored again in a bottom portion of the washing tank 3, and sucked from the water storing section 15 through the circulation opening 22 into the washing and draining pump 20 (washing pump chamber). In such a manner, the wash water stored in the water storing section 15 is circulated within the dish washing machine 1 to be used for washing the dishes.

Further, an inlet opening of the draining pump chamber is connected to a drain opening 25 formed in a left side wall of the water storing section 15, while an outlet opening of the draining pump chamber is connected to a drain channel (not shown) communicated with the outside of the dish washing machine 1. When the pump motor 83 is reversely rotated, a rotation of the drain impeller in the draining pump chamber makes the wash water sucked from the water storing section 15 through the drain opening 25 into the draining pump chamber. The wash water is drained through the drain channel to the outside of the dish washing machine 1.

At the bottom of the washing tank 3, two rotary nozzle arms 26 are disposed right and left for spraying the wash water upwardly from below the lower basket 9B. The two rotary nozzle arms 26 have substantially elliptical long shapes respectively and are supported by a common nozzle base 27 so as to be rotated in a horizontal surface about the longitudinally central portion thereof. The nozzle base 27 is communicated with the water channel 24.

Plural (for example, six) nozzles 28 are provided in an upper surface of each rotary nozzle arm 26. The wash water supplied from the washing and draining pump 20 through the water channel 24 and the nozzle base 27 to each rotary nozzle arm 26 is upwardly sprayed through the nozzles 28 of each rotary nozzle arm 26. When the wash water is sprayed through the nozzles 28 of each rotary nozzle arm 26, a reaction force is generated to each rotary nozzle arm 26, and by this reaction force, each rotary nozzle arm 26 are rotated with spraying the wash water through the nozzles 28. Thereby, the dishes disposed above each rotary nozzle arm 26 are uniformly sprayed with the wash water and can be well washed.

On a rear surface (inner surface) of the washing tank 3, a fixed nozzle arm 29 is provided for spraying the wash water from between the upper basket 9A and the lower basket 9B. The fixed nozzle arm 29 is elongated upwardly from the lower end thereof, and then, at the midway, branched into a first arm 30 and a second arm 31. The lower end of the fixed nozzle arm 29 is communicated with the water channel 24.

The first arm 30 is branched leftward at a position slightly lower than the glass containing section 13 of the upper basket 9A and elongated substantially in the horizontal direction near to the left end of the rear surface 3C. The first arm 30 is provided with nozzles 32 for upwardly spraying the wash water toward glasses put in the most rear row (third row) of the glass containing section 13. The number of the nozzles 32 is equal to the number (four) of glasses containable in the most rear row of the glass containing section 13. Each nozzle 32 is in correspondence with each of four glasses contained in the most rear row of the glass containing section 13, so that the wash water can be sprayed toward the inside of each corresponding glass.

The second arm 31 is elongated further above the branched position of the first arm 30 and bent rightward at a position slightly lower than the small bowl containing section 12, to be elongated substantially in the horizontal direction near to the right end of the rear surface 3C. The second arm 31 is provided with plural (for example, three) nozzles 33 for upwardly spraying the wash water toward the small bowls contained in the small bowl containing section 12. The second arm 31 is further provided with plural (for example, two) impeller-type nozzles 34 for downwardly spraying the wash water toward the large plates contained in the large plate containing section 10. In this impeller-type nozzle 34, an impeller rotates in accompany with the wash water spraying, so that the wash water can be sprinkled in wide range. With the use of these impeller-type nozzles 34, the wash water can be sprayed to the upper portions of large plates which are hard to be sprayed with the wash water from the right side rotary nozzle arm 26.

On the ceiling surface 3D (inner surface) of the washing tank 3, a ceiling nozzle 35 for downwardly spraying the wash water is provided substantially just above the central portion of the glass containing section 13. The ceiling nozzle 35 is connected through a water supply pipe 36 to the washing chamber of the washing and draining pump 20. Therefore, when the pump motor 83 is normally rotated and thereby the washing impeller in the washing pump chamber is rotated, the wash water sucked from the water storing section 15 through the circulation opening 22 into the washing pump chamber is supplied through the water supply pipe 36 to the ceiling nozzle 35, and then downwardly sprayed from the ceiling nozzle 35. The wash water from the ceiling nozzle 35 is diffused right and left and sprayed to positions near just below the ceiling nozzle 35 and positions on the rear side of the ceiling nozzle 35. As a result, the outer surfaces of glasses contained in the second and third rows in the glass containing section 13 (see FIG. 2).

A mesh-type garbage filter 37 is removably attached to an upper edge portion of the water storing section 15. This garbage filter 37 catches garbage removed from the dishes during washing, so that garbage can be prevented from falling into the water storing section 15. An upwardly elongated handle 38 is provided at the center of the front end of the garbage filter 37. Grasping this handle 38, a user can easily attach or remove the garbage filter 37.

The dish washing machine 1 has a function of drying washed dishes. In a portion from the front center to the right end of the bottom surface 3B of the of the washing tank 3 (on the right side of the water storing section 15), a loop-shaped heater 39 is provided for heating the wash water in the washing tank 3 at a washing time and heating air in the washing tank 3 at a drying time. A metal heater cover 40 having plural through holes (not shown) is provided above the heater 39.

Vertically elongated sound insulation seals 41 respectively are attached to right and left end edge portions (on the outer side than the washing tank 3) of the front surface of the box-shaped body 2 (see FIG. 3). Further, vertically elongated water-seal packings 87 are attached to right and left end portions (near to the right and left inner side surfaces 3A of the washing tank 3) of the front surface of the box-shaped body 2 with predetermined spaces from the sound insulation seals 41. The water-seal packings 87 prevent the wash water in the washing tank 3 from leaking to the outside of the dish washing machine 1. When the upper door 5 and the lower door 6 are closed, the right and left end portions of the back surfaces of the upper door 5 and the lower door 6 respectively are in close contact with the water-seal packings 87 and the sound insulation seals 41.

In right and left end portions of the front surface of the box-shaped body 2, arm openings 88A and pawl openings 88B are provided each between the sound insulation seal 41 and the water-seal packing 87. Each arm opening 88A is an opening through which an arm (not shown) connected to the upper door is passed for interlocking the upper door 5 with the lower door 6. Each arm opening 88A is elongated from the upper end of the front surface of the box-shaped body 2 downwardly to a position near the vertical center of the opening 4 (a position behind the right or left end of the upper door 5 when the upper door 5 is closed). Each pawl opening 88B is an opening through which a pawl (not shown) disposed in an upper right end portion or an upper left end portion of the lower door 6 is passed for engaging the lower door 6 with the box-shaped body 2. Each pawl opening 88B is disposed at a position slightly lower than the vertical center of the opening 4 in the box-shaped body 2 (a position behind the upper end of the lower door 6 when the lower door is closed).

With such a structure, sounds leaking from the washing tank 3 through the water-seal packings 87 can be shielded, and at the same time, sounds leaking through the arm openings 88A and the pawl openings 88B (sounds generated when the wash water beats against the inner surface of the washing tank 3 or the like) can be shielded. Therefore, the sounds leaking from the dish washing machine 1 to the outside when the dish washing machine 1 is operated (especially at the washing time) can be reduced.

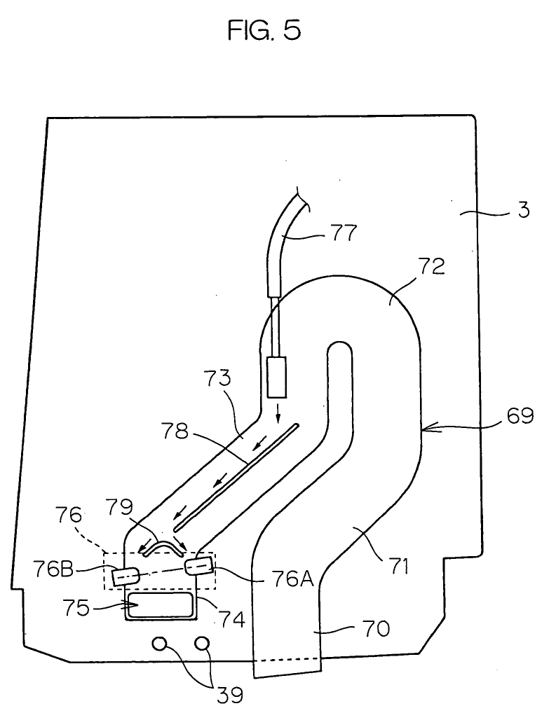

FIG. 5 is a side view of the washing tank 3 seen from the right side and shown schematically for illustrating the inside of an air trunk member 69.

Referring to FIG. 5, the air trunk member 69 is attached to a right side wall of the washing tank 3 from outside. The air trunk member 69 constitutes an air trunk through which an outside air is supplied from a blower (not shown) into the washing tank 3. The air trunk member 69 is hollow member and comprises a root portion 70 upwardly extending from a middle lower portion of the right side of the washing tank 3, a first inclined portion 71 extending rearwardly obliquely and upwardly from the upper end of the root portion 70, a curved portion 72 upwardly extending from the upper end of the first inclined portion 71 and then curved substantially in U-shape to extend downwardly, a second inclined portion 73 obliquely downwardly extending toward a user from the lower end of the curved portion 72, and a terminating portion 74 downwardly extending from the lower end of the second inclined portion 73 to be connected to a blower opening 75 provided in the front lower portion of the right side wall of the washing tank 3.

The lower end of the root portion 70 of the air trunk member 69 is connected to the blower. With a blower motor 85 (see FIG. 6) provided in the blower being driven, the outside air of the dish washing machine 1 is sucked into the air trunk member 69. The outside air sucked into the dish washing machine 1 passes through the air trunk member 69 and is supplied through the blower opening 75 into the washing tank 3. The blower opening 75 is disposed slightly above the heater 39. The air supplied through the blower opening 75 to the bottom portion of the washing tank 3 is heated by the heater 39.

In the terminating portion 74 of the air trunk member 69, a foam sensor 76 for detecting foam formed in the washing tank 3. The foam sensor 76 is, for example, an optical sensor which comprises a light emitting portion 76A attached to the rear surface of the terminating portion 74 for radiating light forwardly (somewhat downward forwardly), and a light receiving portion 76B attached to the front surface of the terminating portion 74 so as to oppose to the light emitting portion 76A for receiving the light radiated from the light emitting portion 76A. When a large amount of foam is formed in the washing tank 3, the foam comes through the blower opening 75 into the air trunk member 69 (into the terminating portion 74). And when the foam coming into the air trunk member 69 reaches an optical axis of the light radiated by the light emitting portion 76A, the light is interrupted by the foam and an amount of the light received by the light receiving portion 76B decreases. Thus, on the basis of the change of the amount of the light detected by the light receiving portion 76B, state of the form generated in the washing tank 3 can be detected.

A distal end of a branched hose 77 branched from the drain channel is connected to the end, on the second inclined portion 73 side, of the curved portion 72 of the air trunk member 69. At the draining time, a part of the wash water drained from the draining pump chamber of the washing and draining pump 20 is introduced through the branched hose 77 into the air trunk member 69, and falls from the curved portion 72 down to the second inclined portion 73. Within the second inclined portion 73 of the air trunk member 69, provided is a first rib 78 extending in the same direction with the extension of the second inclined portion 73. The first rib 78 extends from the upper end to the lower end of the second inclined portion 73, so that the wash water falling from the branched hose 77 down into the second inclined portion 73 is downwardly led along the first rib 78.

At the lower end of the second inclined portion 73, a second rib 79 in a substantially inverted V shape is disposed with a predetermined space from the lower end of the first rib 78. It is so constructed that the wash water downwardly led along the first rib 78 falls down on a top portion of the second rib 79, and therefore, the wash water falling down on the second rib 79 is distributed forwardly and rearwardly. The front end and the rear end of the second rib 79 are disposed respectively adjacent to the light emitting portion 76A and the light receiving portion 76B of the foam sensor 76. It is so constructed that the wash water flowing on the second rib 79 is splashed on the light emitting portion 76A and the light receiving portion 76B. With such a structure, at the draining time, soils like foam attached to the light emitting portion 76A and the light receiving portion 76B can be washed away by the wash water supplied into the air trunk member 69.

FIG. 6 is a block diagram showing an electric arrangement of the dish washing machine 1.

Referring to FIG. 6, an operation of the dish washing machine 1 is controlled by a control section 81 including, for example, a microcomputer. The operation display panel 8 is connected to the control section 81 so as to input and output data. Besides, signals from the water level sensor 16 and the foam sensor 76 can be inputted into the control section 81.

In this embodiment, in the bottom portion of the washing tank 3 (for example, below the heater 39), a temperature sensor 82 is provided for detecting temperature of the wash water (or the tap water) stored in the washing tank 3. The temperature sensor 82 includes a thermistor, and it is so constructed that signals from the temperature sensor are also inputted into the control section 81.

Further, the pump motor 83, the water inlet valve 84, the heater 39 and the blower motor 85 are connected through a load driving section 86 to the control section 81. By controlling the drive of the heater 39 according to the signals from the temperature sensor 82, the temperature of the wash water (the tap water) stored in the washing tank 3 can be controlled.

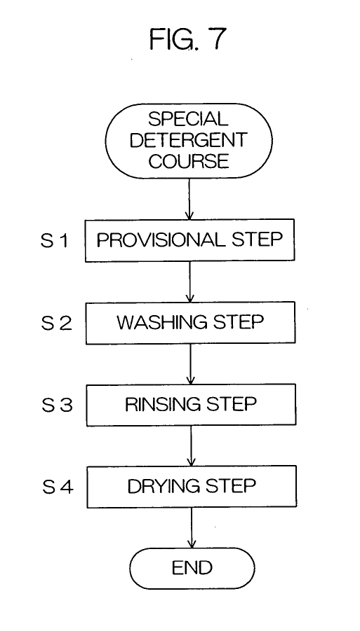

FIG. 7 is a flow chart showing a flow of control by the control section 81 in the special detergent course, in which it is so set that hot water is supplied into the washing tank 3 from the hot water supply installation.

Referring to FIG. 7, in the special detergent course, the control section 81 carries out a provisionary step in which, at the beginning, with opening the water inlet valve 84 for a predetermined time to supply the tap water (the hot water) into the washing tank 3, and the pump motor 83 is reversely rotated to drain the tap water stored in the washing tank 3 (in the water storing section 15) to the outside of the dish washing machine 1 (step S1).

In this dish washing machine 1, the hot water is supplied from the outside hot water supply installation into the washing tank 3, and the supplied hot water in the washing tank 3 is mixed with the special detergent to make the wash water, so that the dishes can be sprayed with the wash water to be sterilized and washed (high temperature washing). In a case of carrying out the high temperature washing, the tap water at ordinary temperature is supplied when a hot water supply from the hot water supply installation into the washing tank 3 is started, and then the temperature of the tap water gradually rises. Therefore, by carrying out the provisional step, the tap water at ordinary temperature supplied into the washing tank 3 at the time of starting the hot water supply can be drained, and the hot water stored in the washing tank 3 can be at sufficiently high temperature.

After the provisional step is ended, the control section 81 carries out a washing step in which the water inlet valve 84 is opened for a predetermined time to supply the tap water into the washing tank 3, and then by normally rotating the washing and draining pump 20, the wash water stored in the washing tank 3 is sprayed toward the dishes (step S2). After that, a rinsing step is carried out (step S3). In the rinsing step, the washing and draining pump 20 is reversely rotated thereby to drain the wash water (or the tap water) stored in the washing tank 3 once, and thereafter the water inlet valve 84 is opened to supply the tap water into the washing tank 3; then the washing and draining pump 20 is normally rotated thereby to spray the tap water stored in the washing tank 3 toward the dishes, and this step is repeated three times (first rinsing, second rinsing and third rinsing); and the heater 39 is driven to heat the tap water stored in the washing tank 3 thereby to operate a step in which the heated tap water is sprayed toward the dishes (heat-rinsing).

After the rinsing step is ended, the control section 81 carries out a drying step in which, with driving the blower motor 85 to introducing the outside air into the washing tank 3, the air in the washing tank 3 is heated by the heater 39 thereby to dry the dishes (step S4).

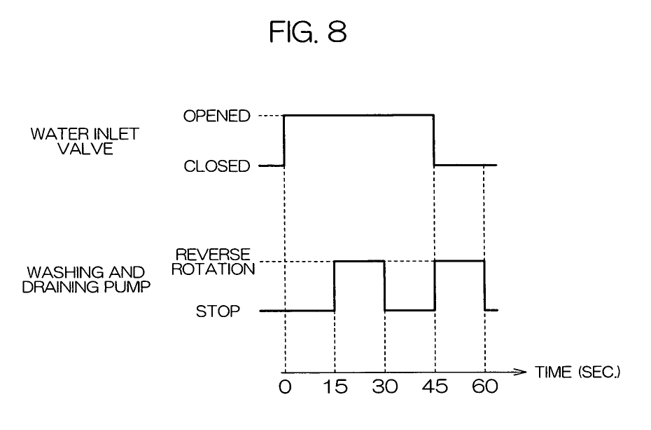

FIG. 8 is a time chart showing operational states of the water inlet valve 84 and the washing and draining pump 20 in the provisional step.

Referring to FIG. 8, in the provisional step, to begin with, the water inlet valve 84 is opened to start supplying water into the washing tank 3. At this time, in the case of the high temperature washing being set, the water inlet valve 84 is opened to supply the hot water from the outside hot water supply installation into the washing tank 3. And when 15 seconds have passed from starting of the provisional step, the washing and draining pump 20 is reversely rotated to start draining.

Thereafter, when 15 seconds (30 seconds from starting of the provisional step) have passed, the driving of the washing and draining pump 20 is stopped. Further, when another 15 seconds (45 seconds from starting of the provisional step) have passed, the water inlet valve 84 is closed and, at the same time, the washing and draining pump 20 is reversely rotated again. And when further 15 seconds (60 seconds from starting of the provisional step) have passed, the driving of the washing and draining pump 20 is stopped to end the provisional step.

By carrying out the provisional step as above-mentioned, garbage left on the bottom surface 3B of the washing tank 3 can be sufficiently washed away, and the water to be stored in the washing tank 3 can be at high temperature in the case of the high temperature washing having been set.

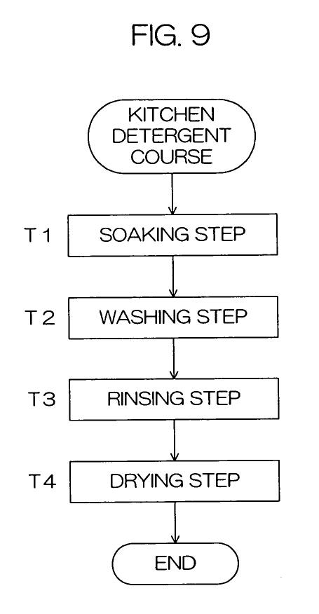

FIG. 9 is a flow chart showing a flow of control by the control section 81 in the kitchen detergent course.

Referring to FIG. 9, in the kitchen detergent course, the control section 81, to begin with, carries out a soaking step in which the water inlet valve 84 is opened for a predetermined time to supply the tap water into the washing tank 3 and the supplied tap water is mixed with the kitchen detergent to make the wash water, thereby to operate a step to spray the wash water stored in the washing tank 3 toward the dishes and leave the dishes for a predetermined time for plural times repeatedly (step T1). In the kitchen detergent course, carrying out the soaking step before the washing step prevents forming a large amount of the foam in the washing tank 3.

In the kitchen detergent course, the soaking step is started without carrying out the provisional step. Unlike the special detergent, the kitchen detergent generally has a lowered washing ability when mixed with high temperature tap water to make the wash water. In the kitchen detergent course, since the provisional step is not carried out, the temperature of the hot water stored in the washing tank 3 can be relatively low even in the case of high temperature washing has been set. This can restrict lowering of the washing ability of the kitchen detergent. As a result, the dishes can be washed better.

Further, the kitchen detergent is liquid, unlike the special detergent. Therefore, if the provisional step is carried out as in the special detergent course, the kitchen detergent supplied into the washing tank 3 is apt to be wholly drained to the outside of the dish washing machine 1 during the provisional step. However, since the kitchen detergent course does not include the provisional step, the kitchen detergent supplied into the washing tank 3 is prevented from being wholly drained to the outside of the dish washing machine 1.

When the soaking step is ended, the control section 81 carries out a washing step in which the washing and draining pump 20 is normally rotated to spray the wash water stored in the washing tank 3 toward the dishes, and thereafter the wash water in the washing tank 3 is once drained (step T2). This washing step corresponds to the washing step in the special detergent course (step S2 in FIG. 7). When the washing step is ended, the control section 81 carries out a rinsing step (step T3) and thereafter a drying step (step T4). The control operations of the control section 81 in the rinsing step and the drying step are the same as that in the special detergent course.

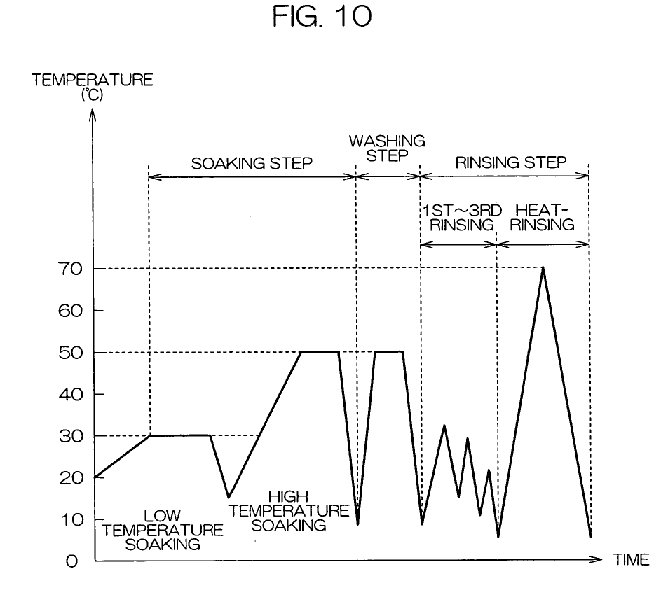

FIG. 10 is a time chart showing an example of temperature change of the wash water (or the tap water) in the washing tank 3 in a case of carrying out the high temperature washing in the kitchen detergent course.

Referring to FIG. 10, in the case of carrying out the high temperature washing in the kitchen detergent course, after the temperature of the wash water in the washing tank 3 is kept at about 30° C. in the soaking step (low temperature soaking), the temperature of the wash water in the washing tank 3 is raised and kept at about 50° C.

In the washing step carried out after the soaking step, the temperature of the wash water in the washing tank 3 is kept at about 50° C. Further, in the rinsing step carried out after the washing step, the temperature of wash water in the washing tank 3 is relatively low (for example, not higher than 40° C.) in the first rinsing to the third rinsing, while the temperature of the wash water in the washing tank 3 in the heat-rinsing is raised to relatively high (for example, about 70° C.).

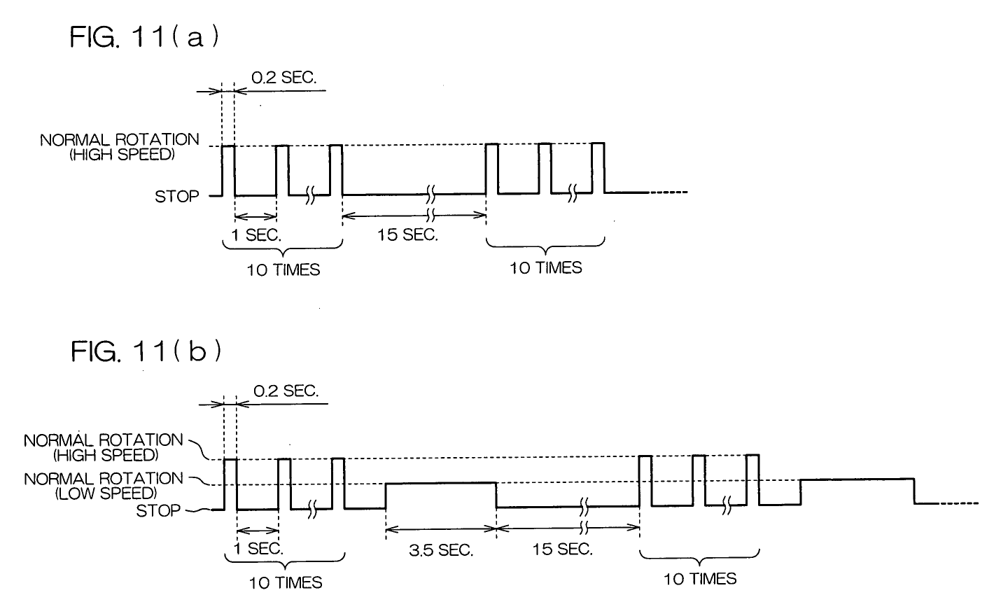

FIGS. 11(a) and (b) are flowcharts showing driving states of the pump motor 83 in the soaking step in the case of carrying out the high temperature washing in the kitchen detergent course. FIG. 11(a) shows the driving state of the pump motor 83 during a low temperature soaking, while FIG. 11(b) shows the driving state of the pump motor 83 during a high temperature soaking.

Referring to FIG. 11, in this embodiment, the driving of the pump motor 83 can be dually changed over between a high speed driving (for example, 3000 rpm) and a low speed driving (for example, 2300 rpm). During the low temperature soaking, such operation is repeated ten times that the pump motor 83 is normally rotated for 0.2 second at high speed and stopped for 1 second. Then the pump motor 83 is stopped for 15 seconds after the tenth high speed rotation, thus carrying out soaking of the dishes in the wash water. While such operation (one cycle) is repeated plural times, it is detected whether more than a predetermined amount of foam is foamed in the washing tank 3 or not on the basis of a sensor signal from the foam sensor 76.

Generally, the more soils are attached to dishes, the less amount of foam is foamed in the washing tank 3, and the less soils are attached to dishes, the more amount of foam is foamed in the washing tank 3. Consequently, the amount of soils attached to the dishes can be detected on the basis of the lapse of time till the foam sensor 76 detects that more than the predetermined amount of foam is foamed in the washing tank 3. With repeating the more times such the driving of the pump motor 83 as abovementioned (one cycle) when the more amount of soils are attached to the dishes. And with repeating the less times such the driving of the pump motor 83 when the less amount of soils are attached to the dishes, the low temperature soaking can be carried out for a time in correspondence with the amount of soils attached to the dishes.

During the high temperature soaking, such operation is repeated ten times that the pump motor 83 is normally rotated for 0.2 second at high speed and stopped for 1 second. Then the pump motor 83 is normally rotated at low speed for 3.5 seconds and stopped for 15 seconds, thus carrying out soaking of the dishes in the wash water. While such operation (one cycle) is repeated plural times, similarly to the case of the low temperature soaking, it is detected whether more than a predetermined amount of foam is foamed in the washing tank 3 or not on the basis of a sensor signal from the foam sensor 76. With repeating the more times such the driving of the pump motor 83 as abovementioned (one cycle) when the more amount of soils are attached to the dishes. And with repeating the less times such the driving of the pump motor 83 when the less amount of soils are attached to the dishes, the high temperature soaking can be carried out for a time in correspondence with the amount of soils attached to the dishes.

When the kitchen detergent (especially the neutral detergent) is used, among soils attached to the dishes, soils containing protein as ingredients thereof can be well removed away by washing with the wash water at about 30° C. In this embodiment, the temperature of the wash water in the washing tank 3 during the low temperature soaking is kept at about 30° C., and therefore soils attached to dishes containing protein can be well removed away. Consequently, even when the kitchen detergent is used to wash the dishes, the dishes can be well washed.

However, the dish washing machine 1 is not limited to a structure in which the temperature of the wash water in the washing tank 3 during the soaking step is kept at a temperature (about 30° C.) appropriate for removing soils containing protein with the kitchen detergent (especially the neutral detergent), but it may have a structure that the temperature of the wash water in the washing tank 3 during the soaking step is kept at another temperature appropriate for removing soils containing other ingredients.

A soaking time during which the dishes are soaked in the wash water in the soaking step is not limited to such a predetermined time as abovementiond, but the soaking step may be carried out in a mode selected from plural modes having different soaking times respectively. For example, a mode may be provided in which the soaking time (15 seconds) in the high temperature soaking in the soaking step is extended to be 25 seconds. In this case, since the dishes are soaked in the wash water for a longer soaking time (25 seconds), soils attached to the dishes are wrapped with ingredients of the kitchen detergent and can be well removed away. Further, in a case the dishes to be washed are few or in the like cases, soils attached to the dishes can be sufficiently removed away in a shorter time by selecting a mode having a shorter soaking time. Consequently, even in a case of washing the dishes with the kitchen detergent, the dishes can be washed better by using a soaking time in correspondence with the amount of soils attached to the dishes. The abovementiond mode may be selected by operating the operation display panel 8, for example.

In some cases, a user wants to use the dish washing machine only for rinsing and drying the dishes after washing the dishes with the kitchen detergent by hands. Therefore, in the dish washing machine 1 according to this embodiment, a course including only rinsing and drying steps (rinsing and drying course) can be carried out.

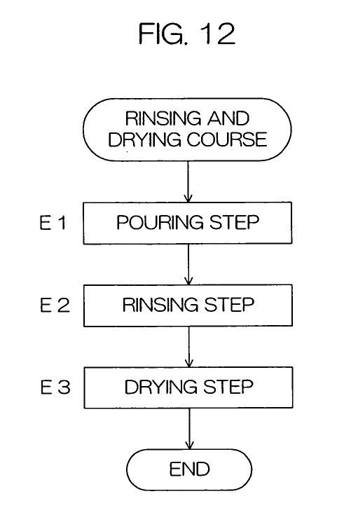

FIG. 12 is a flow chart showing a flow of control by the control section 81 in the rinsing and drying course.

Referring to FIG. 12, in the rinsing and drying course, the control section 81 carries out a pouring step in which a process of firstly opening the water inlet valve 84 for a predetermined time to supply the tap water into the washing tank 3 and then spraying the tap water stored in the washing tank 3 toward the dishes and leaving the dishes for a predetermined time is repeated plural times (step E1).

When the pouring step is ended, the control section 81 carries out a rinsing step (step E2) and thereafter carries out a drying step (step E3). The control operations of the control section 81 in the rinsing and drying course are the same as those in the special detergent course and the kitchen detergent course.

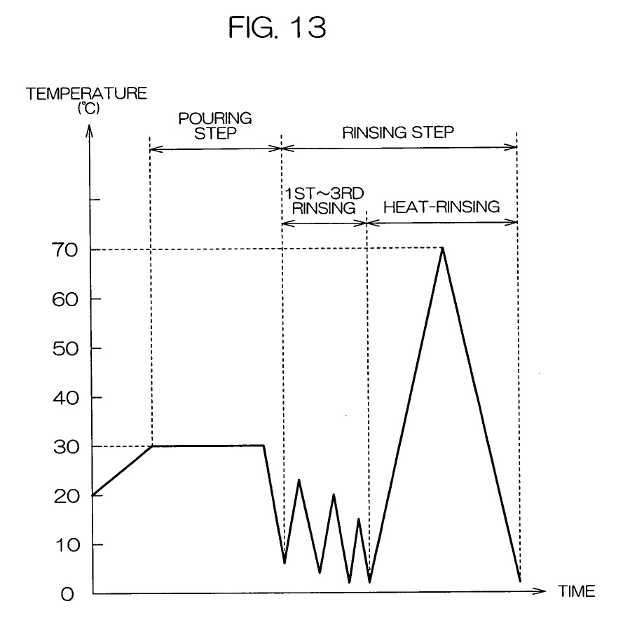

FIG. 13 is a time chart showing an example of the temperature change of the tap water in the washing tank 3 in the rinsing and drying course in a case when the water inlet valve 84 is opened to supply hot water into the washing tank 3.

Referring to FIG. 13, in the rinsing and drying course, the temperature of the tap water in the washing tank 3 is kept at about 30° C. in the pouring step carried out before the rinsing step.

In the rinsing step carried out after the pouring step, the temperature of the wash water in the washing tank 3 is relatively low (for example, not higher than 30° C.) in the first to third rinsing, while the temperature of the wash water in the washing tank 3 is relatively high (for example, about 70° C.) in the heat-rinsing.

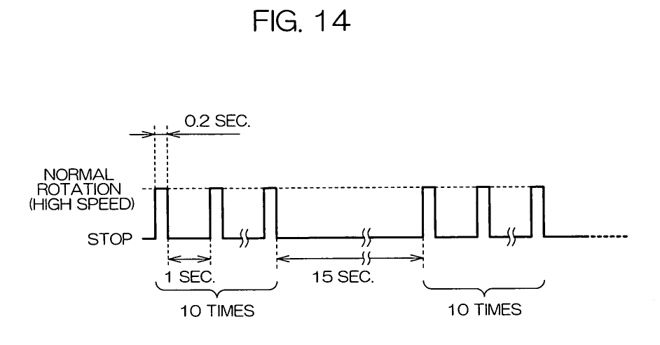

FIG. 14 is a flow chart showing the driving state of the pump motor 83 during the poring step in the rinsing and drying course.

Referring to FIG. 14, in the poring step, the operation of normally rotating the pump motor 83 for 0.2 second at high speed (for example, 3000 rpm) and then stopping the pump motor 83 for 1 second is repeated ten times, and the pump motor 83 is stopped for 15 seconds after the tenth high speed rotation thereof, thus carrying out the pouring of the tap water on the dishes. While such operation (1 cycle) is repeated plural times, it is detected whether more than a predetermined amount of foam is foamed in the washing tank 3 or not on the basis of a sensor signal from the foam sensor 76.

And the shorter the lapse of time till the foam sensor 76 detects that more than the predetermined amount of foam is foamed in the washing tank 3 is (the more amount of the detergent ingredients is left on the dishes), the more times such driving of the pump motor 83 as abovementioned (one cycle) is repeated, and the longer the lapse of time till the foam sensor 76 detects that more than the predetermined amount of foam is foamed in the washing tank 3 is (the less amount of the detergent ingredients is left on the dishes), the less times such driving of the pump motor 83 as abovementioned (one cycle) is repeated. Thus the pouring step can be carried out for a time in correspondence with the amount of the detergent ingredients left on the dishes. Therefore, the detergent ingredients left on the dishes can be well removed away with restricting foam forming to prevent a large amount of foam from being formed in the washing tank 3 during the rinsing step.

The present invention is not limited to the abovementioned description of the embodiment.

For example, in the abovementioned embodiment, the poring step is carried out in the rinsing and drying course. However, it is possible to provide a rinsing course including only the rinsing step and carry out the poring step before the rinsing step in this rinsing course.

Means for spraying the wash water (or the tap water) toward the dishes contained in the dish basket 9 are not limited to the rotary nozzle arm 26, the fixed nozzle arm 29 or the ceiling nozzle 35, but may be a structure including nozzles provided on the right and left side surfaces of the washing tank 3 and the like.

This application corresponds to Japanese Patent Application No. 2003-204964 filed with the Japanese Patent Office on Jul. 31, 2003, the disclosure of which is incorporated herein by reference.

1. A dish washing machine including
a containing tank capable of containing dishes therein,
a wash water spraying means for spraying a wash water toward the dishes contained in the containing tank,
a means for carrying out a washing step for spraying the wash water toward the dishes contained in the containing tank by the wash water spraying means and thereby washing the dishes,
a soaking step carrying out means for carrying out, precedent to the washing step, a soaking step for spraying the wash water toward the dishes contained in the containing tank by the wash water spraying means and leaving the dishes for a predetermined time, and
a water temperature control means for controlling temperature of the wash water to be sprayed toward the dishes in the soaking step so as to be a temperature appropriate for removing soils attached to the dishes.

2. A dish washing machine as set forth in claim 1, in which the water temperature control means keeps the temperature of the wash water at about 30° C.

3. A dish washing machine as set forth in claim 1, in which a user can select one from a special detergent course in which the dishes are washed with a special detergent and a kitchen detergent course in which the dishes are washed with a kitchen detergent.

4. A dish washing machine as set forth in claim 3, in which the soaking step carrying out means functions only when the kitchen detergent course is selected.

5. A dish washing machine as set forth in claim 4, in which the water temperature control means keeps the temperature of the wash water at about 30° C.

6. A dish washing machine including
a containing tank capable of containing dishes therein,
a wash water spraying means for spraying a wash water toward the dishes contained in the containing tank,
a means for carrying out a washing step for spraying the wash water toward the dishes contained in the containing tank by the wash water spraying means and thereby washing the dishes,
a soaking step carrying out means for carrying out, precedent to the washing step, a soaking step for spraying the wash water toward the dishes contained in the containing tank by the wash water spraying means and leaving the dishes for a predetermined time, and
a soaking time control means for changing the predetermined time for leaving the dishes.

7. A dish washing machine as set forth in claim 6, in which a user can select one from a special detergent course in which the dishes are washed with a special detergent and a kitchen detergent course in which the dishes are washed with a kitchen detergent.

8. A dish washing machine as set forth in claim 7., in which the soaking step carrying out means functions only when the kitchen detergent course is selected.

9. A dish washing machine as set forth in claim 8; in which a user can select either of plural washing courses according to the amount and the kind of dishes to be washed, the state of soils attached to the dishes and the like, and
the soaking time control means changes the predetermined time based on the selected course.

10. A dish washing machine capable of carrying out a special detergent course for washing dishes with a special detergent and a kitchen detergent course for washing the dishes with a kitchen detergent, including
a containing tank in which a wash water can be stored, and
a draining means which, when hot water is supplied into the containing tank for washing the dishes, does not drain the hot water stored in the containing tank in the kitchen detergent course, but drains the hot water stored in the containing tank in the special detergent course for a predetermined time from the start of supplying the hot water.

11. A dish washing machine as set forth in claim 10, including a soaking step carrying out means for carrying out, precedent to a washing step, a soaking step for spraying the wash water toward the dishes contained in the containing tank and leaving the dishes for a predetermined time in a case of the kitchen detergent course being selected.

12. A dish washing machine as set forth in claim 11, including a water temperature control means for controlling the temperature of the wash water to be sprayed toward the dishes in the soaking step.

13. A dish washing machine as set forth in claim 12, in which the water temperature control means keeps the temperature of the wash water at about 30° C.

14. A dish washing machine as set forth in claim 11, in which the soaking step carrying out means carries out a low temperature soaking and a high temperature soaking in this order, and
the water temperature control means keeps the temperature of the wash water at about 30° C. in the low temperature soaking and at about 50° C. in the high temperature soaking.

15. A dish washing machine as set forth in claim 14, including a soaking time control means for changing the predetermined time for leaving the dishes between the low temperature soaking and the high temperature soaking.

16. A dish washing machine including
a containing tank capable of containing dishes therein,
a water spraying means for spraying water toward the dishes contained in the containing tank,
a means for carrying out a rinsing step for spraying the water toward the dishes contained in the containing tank by the water spraying means and thereby rinsing the dishes,
a foam removing step carrying out means for carrying out, precedent to the rinsing step, a foam removing step for spraying the water toward the dishes contained in the containing tank by the wash water spraying means and thereby removing foam in the containing tank.

17. A dish washing machine as set forth in claim 16, in which the foam removing step for spraying the water toward the dishes contained in the containing tank by the water spraying means and leaving the dishes for a predetermined time.

18. A dish washing machine as set forth in claim 17, including a water temperature control means for controlling the temperature of the water to be sprayed toward the dishes in the foam removing step.
